(19) United States
(12) Patent Application Publication
(10) Pub. No.: US 2008/0041273 A1
(43) Pub. Date: Feb. 21, 2008

(54) Scratchproof, Radiation-Curable Coatings

(75) Inventors: Hubert Baumgart, Munster (DE); Berthold Austrup, Nordkirchen (DE); Reinhold Schwalm, Wachenheim (DE); Hans-Peter Rath, Grunstadt (DE); Nick Gruber, Mannheim (DE); Erich Beck, Ladenburg (DE); Yvonne Heischkel, Mannheim (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AKTIENGESELLSCHAFT, Munster (DE)

(21) Appl. No.: 11/720,540

(22) PCT Filed: Nov. 28, 2005
(86) PCT No.: PCT/EP05/12674

§ 371 Date: May 31, 2007

(30) Foreign Application Priority Data
Dec. 1, 2004 (DE) 102004058069.3

(51) Int. Cl. C08F 283/12

(52) U.S. Cl. 106/287.13; 525/474; 528/28

(57) ABSTRACT

Scratchproof, radiation-curable coating compositions comprising urethane (meth)acrylates, processes for preparing them, and their use.

The invention relates to scratchproof, radiation-curable coating compositions comprising urethane (meth)acrylates, to processes for preparing them, and to their use.

EP-A1 544 465 describes radiation-curable, alkoxysilylated acrylates.

U.S. Pat. No. 5,939,491 and U.S. Pat. No. 6,187,863 describe heat-curable coating compositions comprising specific polysiloxanes.

U.S. Pat. No. 6,635,341 and U.S. Pat. No. 6,657,001 describe the same polysiloxanes in radiation-curable and dual cure coating compositions. For that purpose, hemiesters of polyols are silylated with 1,2-dianhydrides, which as synthesis components may comprise polylsocyanates. U.S. Pat. No. 6,657,001 moreover, describes 2K [two-component] systems comprising polyacrylate polyol, melamine-formaldehyde resin, and isocyanate, and also polysiloxanes.

A disadvantage of coating compositions of this kind is that they are two-component systems which can easily be incorrectly metered.

It was an object of the present invention to provide one-component binders which are radiation-curable and also, if appropriate, heat-curable and which have a high level of scratch resistance.

This object has been achieved by means of radiation-curable and also, if appropriate, heat-curable binders comprising as synthesis components
(a) at least one compound having at least one isocyanate group (—NCO),
(b) at least one compound comprising at least one silicon atom and at least one isocyanate-reactive group,
(c) at least one compound having at least one isocyanate-reactive group and at least one free-radically polymerizable group,
(d) if appropriate, at least one compound having at least two isocyanate-reactive groups,
(e) if appropriate, at least one compound having one isocyanate-reactive group with no further functional groups, and
(f) if appropriate, at least one compound having at least one isocyanate-reactive group and at least one dispersive group.

The urethane (meth)acrylates of the invention have a higher level of scratch resistance than comparable (meth)acrylates lacking compound (b).

Synthesis components (a) of the binders of the invention are compounds having at least one isocyanate group (—NCO).

Suitable components (a) include, for example, aliphatic, aromatic and cycloaliphatic di- and polyisocyanates having a NCO functionality of at least 1.8, preferably 1.8 to 5 and more preferably 2 to 4, and also their isocyanurates, biurets, allophanates and uretdiones.

Aromatic isocyanates are those containing at least one isocyanate group which are attached directly to an aromatic ring system.

Cycloaliphatic isocyanates are those containing at least one isocyanate group which are attached directly to an alicyclic ring system.

Aliphatic isocyanates are those containing exclusively isocyanate groups which are attached directly to a carbon atom which is disposed in linear or branched chains, in other words acyclic compounds.

The diisocyanates are preferably isocyanates having 4 to 20 carbon atoms. Examples of customary diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, tetramethylxylylene diisocyanate, trimethlhexane diisocyanate or tetramethylhexane diisocyanate, cycloaliphatic diisocyanates such as 1,4-, 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isocyanatomethyl)cyclohexane (isophorone diisocyanate), 1,3- or 1,4-bis(isocyanatomethyl)cyclohexane or 2,4-, or 2,6-diisocyanato-1methylcyclohexane, and also aromatic diisocyanates such as 2,4- or 2,6-tolylene diisocyanate and the isomer mixtures thereof, m- or p-xylylene diisocyanate, 2,4′- or 4,4′-diisocyanatodiphenylmethane and the isomer mixtures thereof, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Mixtures of said diisocyanates may also be present.

Preference is given to hexamethylene diisocyanate 1,3-bis(isocyanatomethyl)-cyclohexane, isophorone diisocyanate, di(isocyanatocyclohexyl)methane, 2,2,4- and 2,4,4-trimethylhexane diisocyanate.

Suitable polyisocyanates include polyisocyanates containing isocyanurate groups. uretidone diisocyanates, polyisocyanates containing biuret groups, polyisocyanates containing urethane or allophanate groups, polyisocyanates comprising oxadiazinetrione groups, uretonimine-modified polyisocyanates of linear or branched C₄-C₂₀-alkylene diisocyanates, cycloaliphatic diisocyanates having 6 to 20 carbon atoms in total, or aromatic diisocyanates having 8 to 20 carbon atoms in total, or mixtures thereof.

The di- and polyisocyanates which can be used preferably have an isocyanate group content (calculated as NCO, molecular weight=42) of 10% to 60% by weight, based on the di- and polyisocyanate (mixture), preferably 15% to 60% by weight and more preferably 20% to 55% by weight.

Preference is given to aliphatic and/or cycloaliphatic di- and polyisocyanates, examples being the aforementioned aliphatic and/or cycloaliphatic diisocyanates, or mixtures thereof.

Preference is further given to
1) polyisocyanates containing isocyanurate groups and derived from aromatic, aliphatic and/or cycloaliphatic diisocyanates. Particularly preferred here are the corresponding aliphatic and/or cycloaliphatic isocyanato-isocyanurates and, in particular, those based on hexamethylene diisocyanate and isophorone diisocyanate. The isocyanurates present are, in particular, trisisocyanatoalkyl or trisisocyanatocycloalkyl isocyanurates, which constitute cyclic trimers of the diisocyanates, or mixtures with their higher homologs containing more than one isocyanurate ring. The isocyanato-isocyanurates generally have an NCO content of 10% to 30% by weight, in particular 15% to 25% by weight, and an average NCO functionally of 3 to 4.5.

2) Uretdione diisocyanates having aromatically, aliphatically and/or cycloaliphatically attached isocyanate groups, preferably aliphatically and/or cycloaliphatically attached groups, and in particular those derived from hexamethylene diisocyanate or isophorone diisocyanate. Uretdione diisocyanates are cyclic dimerization products of diisocyanates.

In the preparations the uretdione diisocyanates can be used as a sole component or in a mixture with other polyisocyanates, particularly those specified under 1).
3) Polyisocyanates containing biuret groups and having aromatically, cycloaliphatically or aliphatically, preferably cycloaliphatically or aliphatically, attached isocyanate groups, especially tris(6-isocyanatohexyl)biuret or its mixtures with its higher homologs. These polyisocyanates containing biuret groups generally have an NCO content of 18% to 22% by weight and an average NCO functionality of 3 to 4.5.
4) Polyisocyanates containing urethane and/or allophanate groups and having aromatically, aliphatically or cycloaliphatically, preferably aliphatically or cycloaliphatically, attached isocyanate groups, such as are obtainable, for example, by reaching excess amounts of hexamethylene diisocyanates or of isophorone diisocyanate with polyhydric alcohols such as, for example, trimethylolpropane, neopentyl glycol, pentaerythritol, 1,4-butanediol, 1,6-hexanediol, 1,3-propanediol,
   ethylene glycol, diethylene glycol, glycerol, 1,2-dihydroxypropane or mixtures thereof. These polyisocyanates containing urethane and/or allophanate groups generally have an NCO content of 12% to 20% by weight and an average NCO functionality of 2.5 to 3.
5) Polyisocyanates comprising oxadiazinetrione groups, derived preferably from hexamethylene diisocyanate or isophorone diisocyanate. Polyisocyanates of this kind comprising oxadiazinetrione groups can be prepared from diisocyanate and carbon dioxide.
6) Unretonimine-modified polyisocyanates.

Polyisocyanate 1) to 6) can be used in a mixture, including if appropriate a mixture with diisocyanates.

Synthesis component (b) is suitably at least one compound comprising at least one silicon atom and at least one isocyanate-reactive group.

The at least one isocyanate-reactive group can be attached directly to a silicon atom and/or to a substituent which is in turn attached to a silicon atom.

In the former case the synthesis component comprises, for example, silanols. silylamines or derivatives of orthosilicic acid. The molar mass may range from 80 (trimethylsilylamine or trimethylsilanol, for example) up to several millions, preferably up to several 100 000s in the case of orthosilicic acid. The synthesis components may also comprise two or more silicon atoms, in which case the silicon atoms are joined to one another preferably via oxygen atoms (silicones, polysiloxanes). These polysiloxane may be linear, branched, cyclic or crosslinked in build-up.

In the second case the at least one isocyanate-reactive group, in contrast, may be attached to a substituent which is in turn attached to a silicon atom. These components may also be obtained, for example, by reacting silanols with epoxides, such as ethylene oxide or propylene oxide, for example, or with (meth)acrylic acid, (meth acrylic esters or acrylonitrile, and carrying out subsequent reduction if appropriate. Another possibility is to react halosilanes, preferably chlorosilanes, with compounds containing at least one halosilane-reactive and at least one isocyanate-reactive group. Preferably the halosilane-reactive and isocyanate-reactive groups are the same. Exemplary of such compounds are 1,2-propanediol, ethylene glycol, 2,2-dimethyl-1,2-ethanediol, 1,3-propanediol, 1,2-butanediol, 1,3-, 1,4-butanediol, 3-methylpentene-1,5-diol, 2-ethylhexane-1,3-diol, 2,4-diethylocatane-1,3-diol, 1,6-hexanediol, diethylene glycol, triethylene glycol, tetraethylene glycol, pentaethylene glycol, trimethylolbutane, trimethylolpropane, trimethylolethane, neopenyl glycol, neopentyl glycol hydroxypivalate, pentaerythritol, 2-ethyl-1,3-diol, glycerol, ditrimethylolpropane, dipentaerythritol, hydroquinone, bisphenol A, bisphenol F, bisphenol B, bisphenol S, 2,2-bis(4-hydroxycyclohexyl(propane, 1,1-, 1,2-, 1,3- and 1,4-cyclohexanedimethanol, 1,2-, 1,3- or 1,4-cyclohexanediol, sorbitol, mannitol, diglycerol, threitol, erythritol, adonitol (ribitol), arabitol (lyxitol), xylitol, dulcitol (galactitol), maltitol, isomalt, 1,2-propanediamine, ethylenediamine, 2,2-dimethyl-1,2-ethanediamine, 1,3-propanediamine, 1,2-butanediamine, 1,4-butanediamine, 2-ethylhexane-1,3-diamine, 2,4-diethyloctane-1,3-diamine, 1,6-hexandiamine, diethylenetriamine, triethylenetetramine, monoethanolamine, diethanolamine, triethanolamine, O-hydroxyethltriethanolamine, monopropanolamine, dipropanolamine, tripropanolamine, dimethylaminoethanolamine, dimethylaminopropanolamine, diethylaminoethanolamine, diethylaminopropanolamine, 1,2-propanolamine, 1,3-propanolamine, 1,4-butanolamine, 1,6-hexanolamine or aminoethylethanolamine.

In the case of compounds (b) with a silicon atom, these compounds may carry, for example, the following substituents: trimethylsilyl, t-butyl dimethylsilyl, diphenyl methylsilyl

Typical compounds (b) having two silicon atoms are hexamethyldisilazane, hexamethyl disilylazide, hexamethyldisilyl acetamide. N,N′-bis[trimethylsilyl]urea or hexamethyldisiloxane.

In one preferred embodiment, synthesis component (b) is at least one organic polysiloxane having reactive functional groups, said polysiloxane having the following structure according to formula (I) 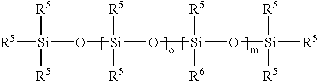
or according to formula (II) 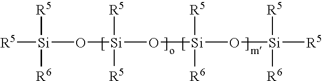
in which
m is at least 1,
m′ is 0 to 50,
o is 0 to 50,
R⁵ is selected from the group consisting of CH and monovalent hydrocarbon groups which are attached to the silicon atoms, and
R⁶ has the following structure of formula (III):
   R⁷—O-Z (III)
   in which
R⁷ is alkylene, oxyalkylene or alkylenearyl and
   Z is hydrogen or a unit which comprises a functional group selected from the group consisting of —OH, —COOH, —NCO, carboxylate, such as ester, carbonate and anhydride, primary amine, secondary amine, amide, carbamate and epoxy-functional groups.

For the organic polysiloxane it is preferably the case that o+m are together 2 or 3 or o+m′ are together 2 or 3.

It is pointed out that the different groups R⁵ can be identical or different, and it is preferably the that the groups R⁵ are identical monovalent hydrocarbon groups.

Monovalent hydrocarbon groups are organic groups which comprise exclusively carbon and hydrogen.

The hydrocarbon groups can be aliphatic, aromatic, cyclic or acyclic and can comprise 1 to 24 (in the case of aromatic groups, 6 to 24) carbon atoms, preferably aliphatic, more preferably those having 1 to 12 carbon atoms, very preferably those having 1 to 4 carbon atoms, especially those having 1 to 2 carbon atoms, and specifically those having one carbon atom.

Optionally, and with less preference, the hydrocarbon groups may be substituted by heteroatoms, typically oxygen.

Examples of monovalent hydrocarbon groups are alkyl, alkoxy, aryl, alkaryl or alkoxyarl groups.

Examples of monovalent hydrocarbon groups are alkyl, alkoxy, aryl, alkaryl or alkoxyarl groups.

Alkylene denotes acyclic or cyclic alkylene groups having a carbon chain length of C₂ to C₂₅. Examples of suitable alkylene groups are
1,2-ethylene, 1,2-propylene, 1,3-propylene, 1,4-butylene, 1,6-hexylene, 2-methyl-1,3-propylene, 2-ethyl-1,3-propylene, 2,2-dimethyl-1,3-propylene or 2,2-dimethyl-1,4-butylene.

Oxyalkylene denotes an alkylene group which comprises at least one ether oxygen atom and has a carbon chain length of C₂ to C₂₅, preferably C₂ to C₄. Examples of suitable oxyalkylene groups are 1-oxa-1,3propylene, 1,4-dioxa-1,6hexylene, 1,4,7-trioxa-1,9-nonylene, 1-1,4-butylene, 1,5-dioxa-1,8-octylene, 1-oxa-1,5-pentylene, 1-oxa-1,7heptylene, 1,6-dioxa-1,10-decylene, 1-oxa-3-methyl-1,3propylene, 1-oxa-3-methyl-1,4-butylene, 1-oxa, 3,3-dimethyl-1,4-butylene, 1-oxa-3,3dimethyl-1,5-pentylene, 1,4-dioxa-3,6dimethyl-1,6-hexylene, 1-oxa-2-methyl-1,3-propylene and 1,4-dioxa-2,5-dimethyl-1,6-hexylene.

Preferred oxyalkylene groups are those associated with trimethylolpropane monoallyl ether, pentaerythritol monoallyl ether, trimethylolpropane diallyl ether, polyethoxylated allyl alcohol and polypropoxylated allyl alcohol.

Alkylenearyl is an acyclic alkylene group which comprises at least one aryl group, preferably phenyl, and has an alkylene carbon chain length of C₂ to C₂₅. The aryl group may optionally be substituted. Suitable groups of substituents may comprise hydroxyl, benzyl, carboxylic acid, and aliphatic groups. Examples of suitable alkylenearyl groups comprise styrene and 3-isopropenyl-α,α-dimethylbenzyl isocyanate.

The formulae (I) and (II) are schematic, and it is not intended to imply that the moieties in brackets are necessarily blocks—although blocks can be used where desired. In many cases the compound is more or less arbitrary, particularly if more than a few siloxane units are used, and if mixtures are used. In those cases where more than a few siloxane units are used, and it is desired to form blocks, oligomers are formed first of all, and they are then connected to form the block compound. By reasonable selection of reactants it is possible to use compounds with an alternating structure, or blocks of alternating structure.

In one preferred embodiment of the invention Z is a unit which comprised
OH-functional groups. If Z comprised OH-functional groups, Z is preferably at least in part a group having the following structure:
   R⁸—(—CH₂—OH)ₚ (IV)
   in which
p can be 1, 2 or 3 and
R⁸ is a p-valent organic radical.

With particular preference, for p=2, R⁸ is 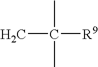
in which R⁸ is C₁ to C₄ alkyl, or, for p=3, R⁸ is 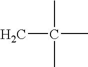
if Z is a group of the formula (IV), preferably m=2 and p is 2.

In another embodiment of the invention Z is a unit which comprised
COOH-functional groups. If Z is a group which comprises COOH-functional groups, the organic polysiloxane is preferably a polysiloxane polyol having the following structure: 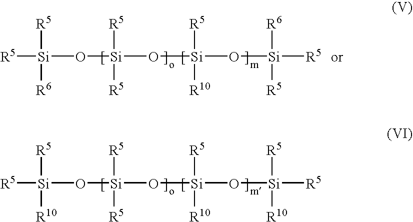
   in which
m is at least 1,
m′ is 0 to 50,
o is 0 to 50,
R⁵ is selected from the group consisting of N, OH and monovalent hydrocarbon groups which are attached to the silicon atoms, and
R¹⁰ has the following structure of the formula (X):
   R⁷—O—Y (IX)
   in which
R⁷ is alkylene, oxyalkylene or alkylenearyl, and
Y is hydrogen, monohydroxy-substituted alkylene or oxyalkylene or has the structure of the formula (IV), in which p, R⁸ and R⁹ are as described above.

Compounds suitable as component (c) include compounds which carry at least one isocyanate-reactive group and at least one free-radically polymerizable group.

Isocyanate-reactive groups may be, for example, —OH, —SH, —NH₂ and —NHR¹, R¹ is hydrogen or an alkyl group comprising 1 to 4 carbon atoms, such as, for example, methyl, ethyl, n-propyl, iso-propyl, n-butyl, iso-butyl, sec-butyl or tert-butyl.

Components (c) can be, for example, monoesters of α,β-unsaturated carboxylic acids, such as acrylic, methacrylic, crotonic, itaconic, fumaric, maleic, acrylamidoglycolic or methacrylamidoglycolic acid, or vinyl ethers of diols or polyols, which preferably have 2 to 20 carbon atoms and at least two hydroxyl groups, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,4- butanediol, 1,5-pentanediol, neopentyl glycol, 1,6-hexanediol, 2-methyl-1,5-pentanediol, 2-ethyl-1,4-butanediol, 1,4-dimethylolcyclohexane, 2,2-bis(4-hydroxycyclohexyl)propane, glycerol, trimethylolethane, trimethylolpropane, trimethylolbutane, pentaerythritol, ditrimethylolpropane, erythritol, sorbitol, poly-THF having a molar weight of between 162 and 2000, poly-1,3-propanediol having a molar weight of between 134 and 400, or polyethylene glycol having a molar weight of between 238 and 458. In addition it is also possible to use esters or amides of (meth)acrylic acid with amino alcohols, e.g., 2-aminoethanol, 2-(methylamino)ethanol, 3-amino-1-propanol, 1-amino-2-propanol or 2-(2-aminoethoxy)ethanol, 2-mercaptoethanol, or polyaminoalkanes, such as ethylenediamine or diethylenetriamine, or vinylacetic acid.

Also suitable, furthermore, are unsaturated polyethenols or polyesterols or polyacrylate polyols having an average OH functionality of 2 to 10.

Examples of amides of ethylenically unsaturated carboxylic acids with amino alcohols are hydroxyalkyl(meth)acrylamides such as N-hydroxymethylacrylamide, N-hydroxymethylmethacrylamide, N-hydroxyethylacrylamide, N-hydroxyethylmethacrylamide, 5-hydroxy-3-oxapentyl(meth)acrylamide, N-hydroxyalkylmaleimides such as N-hydroxyethylmaleimide

Preference is given to using 2-hydroxyethyl (meth)acrylate, 2- or 3-hydroxypropyl (meth)acrylate, 1,4-butanediol mono(meth)acrylate, neopentyl glycol mono(meth)acrylate, 1,5-pentanediol mono(meth)acrylate, 1,5-hexanediol mono(meth)acrylate, glyceryl mono- and di(meth)acrylate, trimethylolpropane mono- and di(meth)acrylate, pentaerythrityl mono-, di- and tri(meth)acrylate, and also 4-hydroxybutyl vinyl ether, 2-aminoethyl (meth)acrylate, 2-aminopropyl (meth)acrylate, 3-aminopropyl (meth)acrylate, 4-aminobutyl (meth)acrylate, 6-aminohexyl (meth)acrylate, 2-thioethyl (meth)acrylate, 2-aminoethyl (meth)acrylamide, 2-aminopropyl (meth)acrylamide, 3-aminopropyl (meth)acrylamide, 2-hydroxyethyl (meth)acrylamide. Particular preference is given to 2-hydroxyethyl acrylate, 2-hydroxyethyl methacrylate, 2- or 3-hydroxypropyl acrylate, 1,4-butanediol monoacrylate and 3-(acryloyloxy)-2-hydroxypropyl methacrylate.

Compounds suitable as optional component (d) include compounds which have at least two isocyanate-reactive groups, such as —OH, —SH, —NH₂ or —NHR², in which R² therein, independently of one another, can be hydrogen, methyl, ethyl, isopropyl, n-propyl, n-butyl, iso-butyl, sec-butyl or tert-butyl.

These are preferably diols or polyols, such as hydrocarbon diols containing 2 to 20 carbon atoms, examples being ethylene glycol, 1,2-propanediol, 1,3-propanediol, 1,1dimethylethane-1,2-diol, 1,6-hexanediol, 1,10decanediol, bis(4-hydroxycycohane)isopropylidene, tetramethylcyclobutanediol, 1,2-, 1,3- or 1,4-cyclohexanediol, cyclooctanediol, norbornanediol, pinanediol, decalindiol, etc., esters thereof with short-chain dicarboxylic acids, such as adipic acid and cyclohexanedicarboxylic acid, carbonates thereof, prepared by reacting the diols with phosgene or by transesterification with dialkyl or diaryl carbonates, or aliphatic diamines, such as methylene- and isopropylidene-bis(cyclohexylamine), piperazine, 1,2-, 1,3- or 1,4diaminocyclohexane, 1,2-, 1,3- or 1,4-cyclohexanebis(methylamine) etc., dithiols or polyfunctional alcohols, secondary or primary amino alcohols, such as ethanolamine, diethanolamine, monopropanolamine, dipropanolamine, etc., or thioalcohols, such as thioethylene glycol.

Thought may also be given to diethylene glycol, triethylene glycol, dipropylene glycol, tripropylene glycol, neopentyl glycol, pentaerythritol, 1,2- and 1,4-butanediol, 1,5-pentanediol, 2-methyl-1,5-pentanediol, 2-ethyl-1,4-butanediol, 1,2-, 1,3- and 1,4-dimethylolcyclohexane, 2,2-bis(4-hydroxycyclohexyl)propane, glycerol trimethylolethane, trimethylolpropane, trimethylolbutane, dipentaerythritol, ditrimethylolpropane, erythritol and sorbitol, 2-aminoethanol, 3-amino-1-propanol, 1-amino-2-propanol or 2-(2-aminoethoxy)ethanol, bisphenol A or butanetriol.

Also suitable, furthermore, are unsaturated polyetherols or polyesterols or polyacrylate polyols having an average OH functionality of 2 to 10, and also polyamines, such as polyethyleneimine, for example, or polymers comprising free amine groups, of poly-N-vinylformamide, for example.

Particularly suitable here are the cycloaliphatic diols, such as bis(4-hydroxycyclohexane)isopropylidene, tetramethylcyclobutanediol, 1,2-, 1,3- or 1,4-cyclohexanediol, cyclooctanediol or norbornanediol, for example.

Optional components (e) are compounds having an isocyanate-reactive group without further functional groups.

Examples thereof are monoalcohols, among which are preferred, particular preference being given to methanol, ethanol, isopropanol, n-propanol, n-butanol, isobutanol, sec-butanol, tert-butanol, ethylene glycol monomethyl ether, ethylene glycol monoethyl ether, 1,3-propanediol monomethyl ether, n-hexanol, n-heptanol, n-octanol, n-decanol, n-dodecanol (lauryl alcohol) and 2-ethylhexanol.

Optional components (f) are compounds having at least one isocyanate-reactive group and at least one dispersive group.

Compounds of this kind are represented, for example, by the general formula
RG-R³-DG
in which
RG is at least one isocyanate-reactive group,
DG is at least one dispersive group, and
R³ is an aliphatic, cycloaliphatic or aromatic radical comprising 2 to 20 carbon atoms.

Examples of RG are —OH, —SH, —NH₂ or —NHR², in which R² has the definition set out above, but may be different form the radical used there.

DG can be either ionic or nonionic.

In the first case, examples of DG are —COOH, —SO₃H or —PO₃H, and their anionic forms, with which any desired counterion may be associated, e.g., Li⁺, Na⁺, K⁺, Cs⁺. Mg²⁺, Ca²⁺, Ba²⁺, ammonium, methylammonium, dimethylammonium, trimethylammonium, ethylammonium, diethylammonium, triethylammonium, tributylammonium, diisopropylethylammonium, benzyldimethylammonium, monoethanolammonium, diethanolammonium, triethanolammonium, hydroxyethyldimethylammonium, hydroxyethldiethylammonium, monopropanolammonium, dipropanolammonium, tripropanolammonium, piperidinium, piperazinium, N,N′-dimethylpiperazinium, morpholinium or pyridinium.

R³ may be, for example, methylene, 1,2-ethylene, 1,2-propylene, 1,3-propylene, 1,2-butylene, 1,4-butylene, 1,3-butylene, 1,6-hexylene, 1,8-octylene, 1,2-dodecylene, 1,2-phenylene, 1,3-phenylene, 1,4-phenylene, 1,2-naphthylene, 1,3-naphthylene, 1,4-naphthylene, 1,6-naphthylene, 1,2-cyclopentylene, 1,3-cyclopentylene, 1,2-cyclohexylene, 1,3-cyclohexylene or 1,4cyclohexylene.

Preferably component (f) is, for example, mercaptoacetic acid, mercaptopropionic acid, thiolactic acid, mercaptosuccinic acid, glycine, iminodiacetic acid, sarcosine, alanine, β-alanine, leucine, isoleucine, aminobutyric acid, hydroxyacetic acid, hydroxypivalic acid, lactic acid, hydroxysuccinic acid, hydroxydecanoic acid, dimethylolpropionic acid, dimethylolbutyric acid, ethylenediaminetriacetic acid, hydroxydodecanoic acid, hydroxyhexadecanoic acid, 12-hydroxystearic acid, aminonaphthalenecarboxylic acid, hydroxyethanesulfonic acid, hydroxypropanesulfonic acid, mercaptoethanesulfonic acid, mercaptopropanesulfonic acid, aminomethanesulfonic acid, taurine, aminopropanesulfonic acid, and the alkali metal, alkaline earth metal or ammonium salts thereof, and with particular preference the stated monohydroxycarboxylic and -sulfonic acids and also monoaminocarboxylic and -sulfonic acids.

For the preparation the aforementioned acids, if they are not already salts, are fully or partly neutralized, preferably with alkali metal salts or amines, preferably tertiary amines.

Compounds (f) may comprise at least one group which is reactive toward isocyanate groups, and at least one hydrophilic group which is cationic or can be converted into a cationic group, and these compounds are, for example, those as described in EP-A1 582 166, particularly from p. 5, I, 42 to p. 8, I, 22 therein, and especially from p. 9, I, 19 to p. 15, I, 34, or in EP-A1 531 820, particularly from p. 3, I, 21 to p. 4, I, 57 therein, or in DE-A1 42 03 510, particularly from p. 3, I, 49 to p. 5, I, 35 therein. Those publications are expressly incorporated by reference into the present disclosure content.

Compounds (f) may comprise at least one group which is reactive toward isocyanate groups, and at least one hydrophilic group which is anionic or can be converted into an anionic group, and these compounds are, for example, those as described in EP-A1 703 255, particularly from p. 3, i, 54 to p. 4, I, 38 therein, in DE-A1 197 24 199, particularly from p. 3, I, 4 to I, 30 therein, in DE-A1 140 10783, particularly from col. 3, I, 3 to I, 40 therein, in DE-A1 41 13 160, particularly from col. 3, I, 63 to col. 4, I, 4 therein, and in EP-A2 548 669, particularly from p. 4, I, 50 to p. 5, I 6 therein. Those publications are expressly incorporated by reference into the present disclosure content.

If DG is a nonionic compound, then compounds (f) may comprise at least one group which is reactive toward isocyanate groups, and at least one nonionic hydrophilic group, and these compounds are, for example, those as described in EP-A2 754 713, particularly from p. 3, II, 31 to 51 therein, in EP-A2 206 059, particularly from p. 8, I, 33 to p. 9, I, 26 therein, in EP-A2 485 881, particularly from p. 2, II, 42 to 54 therein, in EP-A1 540 985, particularly from p. 4, II, 43 to 58 therein, in EP-A1 728 785, particularly from p. 4, I, 55 to p. 5, I, 54 therein, in EP-A1 959 115, particularly from p. 4, II, 23 to 48 therein, in DE-A1 199 58 170, particularly from p. 4, II, 22 to 48 therein, and in DE-A1 100 07 820, particularly from p. 4, I 10 to p. 5, I, 12 therein. These documents are expressly incorporated by reference into the present disclosure content.

The hydrophiles (f) are preferably compounds which comprise at least one group which is reactive toward isocyanate groups, and at least one nonionic hydrophilic group.

Particularly preferred hydrophiles are polyalkylene oxide polyether alcohols, which are obtainable by alkoxylating appropriate starter molecules.

Suitable starter molecules for preparing monohydric polyalkylene oxide polyether alcohols are thiol compounds, monohydroxy compounds of the general formula
R¹¹—O—H
or secondary monoamines of the general formula
R¹²R¹³N—H
in which
R¹¹, R¹² and R¹³ independently of one another are each C₁C₁₈ alkyl optionally interrupted by one or more oxygen and/or sulfur atoms and/or by one or more substituted or unsubstituted imino groups, C₆-C₁₂ aryl, C₆-C₁₂ cycloalkyl or a five- to six-membered heterocycle containing oxygen, nitrogen and/or sulfur atoms, or R¹² and R¹³ together form an unsaturated, saturated or aromatic ring whose members are optionally interrupted by one or more oxygen and/or sulfur atoms and/or by one or more substituted or unsubstituted imino groups, it being possible for the radicals mentioned each to be substituted by functional groups, aryl, alkyl, aryloxy, alkyloxy, halogen, heteroatoms and/or heterocycles.

Preferably R¹¹ is C₁- to C₄ alkyl, i.e., methyl, ethyl, isopropyl, n-propyl, n-butyl, isobutyl, sec-butyl or tert-butyl; very preferably R¹¹ is methyl.

Examples of suitable monofunctional starter molecules may be saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadicanol, n-octadecanol, cyclohexanol, cyclopentanol, the isomeric methylcyclohexanols or hydroxymethylcyclohexane, 3-ethyl-3-hydroxymethyloxetane, or tetrahydrofurfuryl alcohol: unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinamyl alcohol; secondary monoamines such as dimethylamine, diethylamine, dipropylamine, diisopropylamine, di-n-butylamine, diisobutylamine, bis(2-ethylhexyl)amine, N-methyl- and N-ethylcyclohexylamine or dicyclohexylamine, heterocyclic secondary amines such as morpholine, pyrrolidine, piperdine or 1H-pyrazole, and amino alcohols such as 2-dibutylaminoethanol, 2-diethylaminoethanol, 2-diisopropylaminoethanol, 2-dibutylaminoethanol, 3-(dimethylamine)-1-propanol or 1-(dimethylamino)-2-propanol.

Alkylene oxides suitable for the alkoxylation reaction are ethylene oxide, propylene oxide, isobutylene oxide, vinyloxirane and/or styrene oxide, which may be used in any order or else in a mixture in the alkoxylation reaction.

Preferred alkylene oxides are ethylene oxide, propylene oxide and mixtures thereof, particular preference being given to ethylene oxide.

Preference is given to polyether alcohols based on polyalkylene oxide polyether alcohols, prepared using saturated aliphatic or cycloaliphatic alcohols of the abovementioned type as starter molecules. Very particular preference is given to those based on polyalkylene oxide polyether alcohols prepared using saturated aliphatic alcohols having 1 to 4 carbon atoms in the alkyl radical. Polyalkylene oxide polyether alcohols prepared starting from methanol are especially preferred.

The monohydric polyalkylene oxide polyether alcohols contain on average generally 5 to 35, preferably 7 to 30, more preferably 7 to 25, and very preferably 10 to 22 alkylene oxide units per molecule, in particular 10 to 22 ethylene oxide units.

Preferred polyether alcohols are compounds of formula
R¹¹—O—[—Xᵢ]ₓ-H
in which
R¹¹ is as defined above,
k is an integer from 5 to 35, preferably 7 to 30, more preferably 7 to 25, and especially 10 to 22, and
each Xᵢ can be selected, independently of one another for i=1 to k, from the group consisting of —CH₁—CH₂—O—, CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O— and —CHPh-CH₂—O—, preferable from the group consisting of —CH₂—CH₂—O—, —CH₂—CH(CH₃)—O— and —CH(CH₃)—CH₂—O—, and more preferably —CH₂—CH₂—O—
in which Ph is phenyl and Vin is vinyl.

The polyether alcohols may further comprise, as hydrophilic synthesis components, minor amounts of further isocyanate-reactive compounds having anionic or cationic groups—for example, containing carboxylate, sulfonate or ammonium groups. This, however, is less preferred.

There polyurethanes are obtained by reacting components (a), (c) and (d) with one another.

The molar composition (a):(b):(c) per 3 mol of reactive isocyanate groups in (a) is generally as follows:
(b) 0.1-2.25, preferably 0.2-2.0, more preferably 0.3-1.8, and in particular 0.5-1.5 mol of isocyanate-reactive groups and
(c) 0.75-2.9, preferably 1.0-2.8, more preferably 1.2-2.7, and especially 1.5-2.5 mol of isocyanate-reactive groups.

If appropriate it is possible in addition for components (d), (e) and (f) to be present, per 3 mol of reactive isocyanate groups in (a), in amounts as follows:
(d) 0 2.0 mol of isocyanate-reactive groups, preferably 0-1.5, more preferably 0.11.0 and very preferably 0.5-1.0.
(e) 0 to 0.5 mol of isocyanate-reactive groups, preferably 0-0.3, more preferably 0-0.2 and very preferably 0-0.2, and
(f) 0 to 0.5 mol of isocyanate-reactive groups, preferably 0-0.3, more preferably 0-0.2, and very preferably 0-0.2.
   with the proviso that the isocyanate-reactive groups do not exceed the number of isocyanate groups.

Preferred compounds of the invention have a molar weight in the range from 500 to 5000, preferably from 500 to 3000 g/mol.

The glass transition temperatures of the uncured compounds are preferably in the range from −80° C. to 100° C., preferably in the range from −60° C. to 25° C.

The adduct of isocyanate-groups-containing compound and the compound which comprises groups that are reactive toward isocyanate groups is generally formed by mixing the components in arbitrary order, if appropriate at elevated temperature.

The compound which comprises groups that are reactive toward isocyanate groups is preferably added to the compound containing isocyanate groups, preferably in two or more steps.

With particular preference the compound containing isocyanate groups is introduced initially and the compounds which comprise isocyanate-reactive groups are added. In particular the isocyanate-groups-containing compound (a) is introduced initially and thereafter (b) is added. Subsequently it is possible, if appropriate, to add desired further components.

In general the reaction is carried out at temperatures between 5 and 100° C., preferably between 20to 90° C. and more preferably between 40 and 80° C., and in particular between 60 and 80° C.

This reaction is preferably operated under anhydrous conditions.

Anhydrous means in this context that the water content of the reaction system is not more than 5% by weight, preferably not more than 3% by weight, and more preferably not more than 1% by weight.

The reaction is preferably carried out in the presence of at least one suitable inert gas, examples being nitrogen, argon, helium, carbon dioxide or the like.

The reaction can also be carried out in the presence of an inert solvent, examples being acetone, isobutyl methyl ketone, toluene, xylene, butyl acetate or ethoxyethyl acetate. Preferably, though, the reaction is carried out in the absence of a solvent.

The present invention additionally provides a radiation-curable or radiation- and heal-curable coating composition comprising
(A) at least one urethane (meth)acrylate of the invention,
(B) if appropriate, at least one polymer having ethylenically unsaturated groups and an average molar mass Mₙ of more than 2000 g/mol,
(C) if appropriate, at least one compound having ethylenically unsaturated groups and an average molar mass Mₙ of less than 2000 g/mol,
(D) at least one photoinitiator, and
(E) if appropriate, further typical coatings additives.
   re (B):

Suitable polymers are, for example, polymers of ethylenically unsaturated compounds, but also polyesters, polyethers, polycarbonates, polyepoxides or polyurethanes, having a molar mass of more than 200 g/mol, and being different from (A).

Suitable examples include unsaturated polyester resins, which are composed essentially of polyols, especially diols, and polycarboxylic acid, especially dicarboxylic acid, with one of the esterification components comprising a copolymerizable ethylenically unsaturated group. This component is, for example, maleic acid, fumaric acid or maleic anhydride.

Preferred polymers are those of ethylenically unsaturated compounds such as are obtained in particular by means of free-radical polymerization.

The free-radically polymerized polymers are, in particular, polymers synthesized from more than 40%, more preferably more than 60%, by weight of acrylic monomers, especially C₁-C₈, preferably C₁-C₄ alkyl (meth)acrylates, more preferably methyl (meth)acrylate, ethyl (meth)acrylate or n-butyl (meth)acrylate.

As ethylenically unsaturated groups the polymers comprise, for example, vinyl others and/or, in particular, (meth)acrylic groups. These may be attached to the polymer by means, for example, of reaction of (meth)acrylic acid with epoxide groups in the polymer (e.g., by including glycidyl (meth)acrylate as a comonomer).

Epoxide (meth)acrylates are obtainable by reading epoxides with (meth)acrylic acid. Examples of suitable epoxides include epoxidized olefins, aromatic glycidyl ethers or aliphatic glycidyl ethers, preferably those of aromatic or aliphatic glycidyl ethers.

Examples of epoxidized olefins may include ethylene oxide, propylene oxide, isobutylene oxide, 1-butene oxide, 2-butene oxide, vinyloxirane, styrene oxide or epichlorohydrin, preference being given to ethylene oxide, propylene oxide, isobutylene oxide, vinyloxirane, styrene oxide or epichlorohydrin, particular preference to ethylene oxide, propylene oxide or epichlorohydrin, and very particular preference to ethylene oxide and epichlorohydrin.

Examples of aromatic glycidyl ethers include bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2.5-bis[2,3-epoxypropoxy)phenyl]octahydro-4,7-methano-5H-indene) (CAS no. [13446-85-0]tris[4-(2,3-epoxypropoxy)phenyl]methane isomers (CAS no. [66072-39-7]), phenol-based epoxy novolaks (CAS no. [9003-35-4]) and cresol-based epoxy novolaks (CAS no. [37382-79-9]).

Example of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS no. [27043-37-4]), diglycidyl ethers of polypropylene glycol (α,ω-bis(2,3-epoxypropoxy)-poly(oxypropylene) CAS no. [16096-30-3]) and of hydrogenated bisphenol A (2,2-bis[4-(2,3-epoxypropoxy)cyclohexyl]propane, CAS no. [134 10-58-7]).

The epoxide (meth)acrylates and epoxide vinyl ethers preferably have a number-average molar weight Mₙ of 2000 to 20,000, more preferably of 2000 to 10 000 g/mol and very preferably of 2000 g/mol to 3000 g/mol; the amount of (meth)acrylic or vinyl ether groups is preferably 1 to 5, more preferably 2 to 4, per 1000 g of epoxide (meth)acrylate or vinyl ether epoxide (determined by gel permeation chromatography using polystyrene as standard and tetrahydrofuran as eluent).

Preference is likewise given to polyurethanes. These preferably comprise, as unsaturated groups, likewise (meth)acrylic groups, which are attached to the polyurethane, for example, by reaching hydroxyalkyl (meth)acrylates with isocyanate groups.

Urethane (meth)acrylates of this kind are obtainable, for example, by reacting polyisocyanates with hydroxyalkyl (meth)acrylates or hydroxyalkyl vinyl ethers and, if appropriate, chain extenders such as diols, polyols, diamines, polyamines or dithiols or polythiols. Urethane (meth)acrylates which can be dispersed in water without the addition of emulsifiers further comprise ionic and/or nonionic hydrophilic groups, which are introduced into the urethane by means, for example, of synthesis components such as hydroxyl carboxylic acids.

The polyurethanes which can be used as binders comprise as synthesis components essentially:
(a) at least one organic aliphatic, aromatic or cycloaliphatic di- or polyisocyanate,
(c) at least one compound having at least one isocyanate-reactive group and at least one free-radically polymerizable unsaturated group, and
(d) if appropriate, at least one compound having at least two isocyanate-reactive groups.

These polyurethanes are obtained by reacting components (a), (c) and (d) with one another.

The molar composition (a):(c):(d) per 3 mol of reactive isocyanate groups in (a) is generally as follows:
(c) 1.5-3.0, preferably 2.0-2.9, more preferably 2.0-2.5, and in particular 2.0-2.3 mol of isocyanate-reactive groups and
0-1.5, preferably 0.1-1.0, more preferably 0.5-1.0, and in particular 0.7-1.0 mol of isocyanate-reactive groups.

When the polyurethanes are used in aqueous systems, essentially all of the isocyanate groups present have preferably been consumed by reaction.

The adduct of isocyanate-groups-containing compound and the compound which comprises groups that are reactive toward isocyanate groups is generally formed by mixing the components in arbitrary order, if appropriate at elevated temperature.

The compound which comprises groups that are reactive toward isocyanate groups is preferably added to the compound containing isocyanate groups, preferably in two or more steps.

With particular preference the compound isocyanate groups is introduced initially and the compounds which comprise isocyanate-reactive groups are added. In particular the isocyanate-groups-containing compound (a) is introduced initially and thereafter (c) is added. Subsequently it is possible, if appropriate, to add desired further components.

In general the reaction is carried out at temperatures between 5 and 100° C., preferably between 20 to 90° C. and more preferably between 40 and 80° C., and in particular between 60 and 80° C.

This reaction is preferably operated under anhydrous conditions.

Anhydrous means in this context that the water content of the reaction system is not more than 5% by weight, preferably not more than 3% by weight, and more preferably not more than 1% by weight.

The reaction is preferably carried out in the presence of at least one suitable inert gas, examples being nitrogen, argon, helium, carbon dioxide or the like.

The reaction can also be carried out in the presence of an inert solvent, examples being acetone, isobutyl methyl ketone, toluene, xylene, butyl acetate or ethoxyethyl acetate. Preferably, though, the reaction is carried out in the absence of a solvent.

The urethane (meth)acrylates preferably have a number-average molar weight Mₙ of 2000 to 20 000, in particular of 2000 to 10 000, and more preferably 2000 to 3000 g/mol (determined by gel permeation chromatography with tetrahydrofuran and polystyrene as standard).

The urethane (meth)acrylates preferably have a (meth)acrylic group content of 1 to 5, more preferably of 2 to 4mol per 1000 g of urethane (meth)acrylate.

The urethane vinyl ethers preferably have a vinyl ether group content of 1 to 5, more preferably 2 to 4, mol per 1000 g of urethane vinyl ether.

It represents a preferred embodiment of this invention that the urethane (meth)acrylates or urethane vinyl ethers, preferably urethane acrylates, comprise as synthesis component at least one cycloaliphatic isocyanate, i.e., a compound in which at least one isocyanate group is attached to a cycloaliphatic structure, and more preferably IPDI.

In a further preferred embodiment use is made of compounds as described in WO 00/39183, p. 4, I, 3 to p. 10, I, 19, the disclosure content of which is hereby made part of the present specification. Particular preference among these compounds is given to those which include as synthesis components at least one (cyclo)aliphatic isocyanate containing allophanate groups and at least one hydroxyalkyl (meth)acrylate, and very particular preference to products no. 1 to 9 in Table 1 on p. 24 of WO 00/39183.

Radiation-curable compounds that are additionally suitable are carbonate (meth)acrylates which comprise on average preferably 1 to 5, especially 2 to 4, more preferably 2 to 3 (meth)acrylic groups and with very particular preference 2 (Meth)acrylic groups.

The number-average molecular weight Mₙ of the carbonate (meth)acrylates is preferably 2000 to 3000 g/mol (determined by gel permeation chromatography using polystyrene as standard, tetrahydrofuran as solvent).

The carbonate (meth)acrylates are obtainable in a simple way by transesterification of carbonic esters with polyhydric, preferably dihydric, alcohols (diols, e.g., hexanediol) and subsequent esterification of the free OH groups with (meth)acrylic acid or else transesterification with (meth)acrylic esters, as is described, for example, in EP-A 92 269. They are also obtainable by reacting phosgene, urea derivatives with polyhydric, e.g., dihydric, alcohols.

In a similar way it is also possible to obtain vinyl ether carbonates, by reacting a hydroxyalkyl vinyl ether with carbonic esters and also, if appropriate, with dihydric alcohols.

Also conceivable are (meth)acrylates or vinyl ethers of polycarbonate polyols, such as the reaction product of one of the aforementioned diols or polyols and a carbonic ester and also a hydroxyl-containing (meth)acrylate or vinyl ether.

Examples of suitable carbonic esters include ethylene carbonate, 1,2- or 1,3-propylene carbonate, and dimethyl, diethyl or dibutyl carbonate.

Examples of suitable hydroxyl-containing (meth)acrylates include 2-hydroxyethyl (meth)acrylate, 2- or 3-hydroxypropyl (meth)acrylate, 1,4-butanediol mono(meth)acrylate, neopentyl glycol mono(meth)acrylate, glyceryl mono- and di(meth)acrylate, trimethylolpropane mono- and di(meth)acrylate, and also pentaerythrityl mono-, di- and tri(meth)acrylate.

Examples of suitable hydroxyl-containing vinyl ethers include 2-hydroxyethyl vinyl ether and 4-hydroxybutyl vinyl ether.

Particularly preferred carbonate (meth)acrylates are those of the formula: 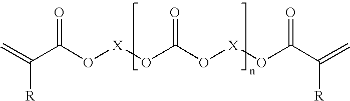
in which R is H or CH₃, X is a C₂-C₁₈ alkylene group and n is an integer from 1 to 5, preferably 1 to 3.
R is preferably H and X is preferably C₂ to C₁₀ alkylene, examples being 1,2-ethylene, 1,2-propylene, 1,3-propylene, 1,4-butylene of 1,6-hexylene, and with particular preference is C₄ to C₈ alkylene. With very particular preference X is C₅ alkylene.

The compounds in question are preferably aliphatic carbonate (meth)acrylates.

re (C)

The coating composition of the invention may also comprise ethylenically unsaturated compounds of low molecular mass (reactive diluents).

By compounds of low molecular mass are meant, in this context, compounds having a number-average molecular weight of below 2000 g/mol (determined by gel permeation chromatography using polystyrene as standard).

These may be compounds, examples being those set out under (B), which have a molar mass of less than 2000 g/mol, examples being epoxide (meth)acrylates having a molar mass of 340, preferably 500 and more preferably 750 to below 2000 g/mol, urethane (meth)acrylates having a molar mass of 300, preferably 500 and more preferably 750 to below 2000 g/mol, or carbonate (meth)acrylates having a molar mass of 170, preferably 250 and more preferably 500 to below 2000 g/mol.

Suitability is further possessed, for example, by free-radically polymerizable compounds having only one ethylenically unsaturated, copolymerizable group.

Examples that may be mentioned include C₁-C₂₀ alkyl (meth)acrylates, vinylaromatics having up to 20 carbon atoms, vinyl esters of carboxylic acids comprising up to 20 carbon atoms, ethylenically unsaturated nitriles, vinyl ethers of alcohols comprising 1 to 10 carbon atoms, and aliphatic hydrocarbons having 2 to 20, preferably 2 to 8, carbon atoms and 1 or 2 double bonds, and also (meth)acrylic acid.

Preferred (meth)acrylic acid alkyl esters are those having a C₁-C₁₀ alkyl radical, such as methyl methacrylate, methyl acrylate, n-butyl acrylate, ethyl acrylate and 2-ethylhexyl acrylate.

In particular, mixtures of the (meth)acrylic acid alkyl esters are also suitable.

Vinyl esters of carboxylic acids having 1 to 20 carbon atoms are, for example, vinyl taurate, vinyl stearate, vinyl propionate and vinyl acetate.

Suitable vinylaromatic compounds include, for example, vinyltoluene, α-butylstyrene, 4-n-butylstyrene, 4-decylstyrene and, preferably, styrene.

Examples of nitriles are acrylonitrile and methacrylonitrile.

Suitable vinyl ethers are, for example, vinyl methyl ether, vinyl isobutyl ether, vinyl hexyl ether and vinyl octyl ether.

As nonaromatic hydrocarbons having 2 to 20, preferably 2 to 8, carbon atoms and one or two olefinic double bonds mention may be made of butadiene, isoprene, and also ethylene, propylene and isobutylene.

Suitability is possessed preferably by free-radically polymerizable compounds having two or more ethylenically unsaturated groups.

These are, in particular, (meth)acrylate compounds, preference being given in each case to the acrylate compounds, i.e., to the derivatives of acrylic acid.

Preferred (meth)acrylate compounds contain 2 to 20, preferably 2 to 10 and more preferably 2 to 6 copolymerizable, ethylenically unsaturated double bonds.

As (meth)acrylate compounds mention may be made of (meth)acrylic esters and especially acrylic esters of polyfunctional alcohols, particularly those which, apart from the hydroxyl groups, comprise no further functional groups or at best ether groups. Examples of such alcohols are, for example, bifunctional alcohols, such as ethylene glycol, propylene glycol, and representatives thereof with higher degrees of condensation, such as, for example, diethylene glycol, triethylene glycol, dipropylene glycol, tripropylene glycol, etc., butanediol, pentanediol, hexanediol, neopentyl glycol, alkoxylated phenolic compounds, such as ethoxylated and/or propoxylated bisphenols, cyclohexanedimethanol, trifunctional and higher polyfunctional alcohols, such as glycerol, trimethylolpropane, trimethylolethane, neopentyl glycol, pentaerythritol, glycerol, ditrimethylolpropane, dipentaerythritol, sorbitol, mannitol, diglycerol, 1,2-propanediol, ethylene glycol, 2,2-dimethyl-1,2-ethanediol, neopentyl glycol, 1,3-propanediol, 1,2-butanediol, 1,4-butanediol, butanetriol, sorbitol, mannitol, and the corresponding alkoxylated, especially ethoxylated and propoxylated, alcohols.

The alkoxylation products are obtainable in a known way by reacting the above alcohols with alkylene oxides, examples being ethylene oxide, propylene oxide, butylene oxide, isobutylene oxide and vinyloxirane, in any order or as a mixture, preferably ethylene oxide and/or propylene oxide, and more preferably ethylene oxide. The degree of alkoxylation per hydroxyl group is preferably 0 to 10, i.e., 1 mol of hydroxyl group can be alkoxylated preferably with up to 10 mol of alkylene oxides.

Polyether alcohols containing vinyl ether groups are obtained, for example, correspondingly by reaction of hydroxyalkyl vinyl ethers with alkylene oxides.

Polyether alcohols containing (meth)acrylic acid groups can be obtained, for example, by transesterifying (meth)acrylic acid esters with the polyether alcohols, by esterifying the polyether alcohols with (meth)acrylic acid, or by using hydroxyl-containing (meth)acrylates as described above under (c).

Preferred polyether alcohols are polyethylene glycols having a molar mass of between 106 and 2000, preferably between 106 and 898 and more preferably between 238 and 678.

As polyether alcohols it is additionally possible to use poly-THF having a molar mass of between 162 and 2000 and also poly-1,3-propanediol having a molar mass of between 134 and 1178.

Further (meth)acrylate compounds that may be mentioned include polyester (meth)acrylates, which are the (meth)acrylic esters of polyesterols.

Polyester polyols are known for example from Ullmanns Encyklopädie der technischen Chemie, 4th Edition, Volume 19, pp. 62 to 65. It is preferred to use polyester polyols obtained by reacting dihydric alcohols with dibasic carboxylic acids. Instead of the free polycarboxylic acids it is also possible to use the corresponding polycarboxylic anhydrides or corresponding polycarboxylic esters of lower alcohols, or mixtures thereof, to prepare the polyester polyols. The polycarboxylic acids can be aliphatic, cycloaliphatic, araliphatic, aromatic or heterocyclic and if appropriate may be substituted, by halogen atoms for example, and/or unsaturated. Examples of these acids that may be mentioned include the following:

oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, examples being C₁-C₄ alkyl esters, preferably methyl, ethyl or n-butyl esters, or said acids. Preference is given to dicarboxylic acids of the general formula HOOC—(CH₂)_{y}-COOH, where y is a number from 1 to 20, preferably an even number from 2 to 20, particular preference being given to succinic acid, adipic acid, sebacic acid and dodecanedicarboxylic acid.

Polyhydric alcohols suitable for preparing the polyesterols include 1,2-propanediol, ethylene glycol, 2,2dimethyl-1,2-ethanediol, 1,3-propanediol, 1,2-butanediol, 1,3-butanediol, 1,4- butanediol, 3-methylpentane-1,5-diol, 2-ethylhexane-1,3-diol, 2,4-diethyloctane-1,3-diol, 1,6hexanediol, poly-THF having a molar mass of between 102 and 2000, poly-1,3-propanediol having a molar mass of between 134 and 1178, poly-1,2-propanediol having a molar mass of between 134 and 898, polyethylene glycol having a molar mass of between 106 and 453, neopentyl glycol, neopentyl glycol hydroxypivalate, 2-ethyl-1,3propanediol, 2-methyl-1,3-propanediol, 2,2-bis(4-hydroxycyclohexyl)propane, 1,1-, 1,2-, 1,3- and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), malitol or isomalt.

Preferred alcohols are those of the general formula HO—(CH₂)ₓ-OH, where x is a number from 1 to 20, preferably an even number from 2 to 20. Preference is given to ethylene glycol, butane-1,4-diol, hexane-1,6-diol, octane-1,8-diol and dodecane-1,12-ethylene diol. Further preference is given to neopentyl glycol.

Also suitable, furthermore, are polycarbonate diols, such as may be obtained, for example, by reacting phosgene with an excess of the low molecular mass alcohols specified as synthesis components for the polyesterpolyols.

Also suitable are lactone-based polyester diols, which are homopolymers or copolymers of lactones, preferably adducts, containing terminal hydroxy groups, of lactones with suitable difunctional starter molecules. Suitable lactones are preferably those

derived from compounds of the general formula HO—(CH₂)_{z}-COOH, where z is a number from 1 to 20 and where one hydrogen atom of a methylene unit may also be substituted by a C₁ to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Suitable starter components are, for example, the low molecular mass dihydric alcohols mentioned above as a synthesis component for the polyester polyols. The corresponding polymers of ε-caprolactone are particularly preferred. Lower polyester diols or polyether diols, as well, can be used as starters for preparing the lactone polymers. Instead of the polymers of lactones it is also possible to use the corresponding, chemically equivalent polycondensates of the hydroxy carboxylic acids corresponding to the lactones.

Polyester (meth)acrylates can be prepared in two or more stages or else in one stage, as described for example in EP 279 303, from acrylic acid, polycarboxylic acid and polyol.

The coating compositions of the invention (based on the solids content, i.e., absent solvent) are generally as follows in terms of composition:
(A) at least 20%, preferably at least 30%, more preferably at least 50%, very preferably at least 60%, in particular at least 75% and especially at least 80% by weight, and up to 100%, preferably up to 98%, more preferably up to 95%, very preferably up to 90%, and in particular up to 85% by weight, of component A
(B) if appropriate, up to 70%, preferably up to 50%, more preferably up to 25%, very preferably up to 10%, in particular up to 5%, and especially 0% by weight, of component B
(C) if appropriate, up to 50%, preferably up to 25%, more preferably up to 10%, very preferably up to 5%, and in particular 0% by weight, of component C
   with the proviso that the sum is always 100% by weight.

Preferably the coating material (with solvent comprised if appropriate) has a viscosity of 0.02 to 100 Pas at 25° C. (determined in a rotational viscometer)

The radiation-curable compositions may comprise further constituents. Particular mention may be made of photoinitiators, leveling agents, and stabilizers. For outdoor applications, i.e., for coatings exposed directly to daylight, the compositions comprise, in particular, UV absorbers and free-radical scavengers.

As accelerants for the thermal aftercure it is possible, for example, to use tin octoate, zinc octoate, dibutyltin laureate or diazabicyclo[2.2.2]octane.

In the case of use as coating material, the compositions usually comprise 0.1 to 10.0% by weight, preferably 0.5 to 7.0% by weight, of photoinitiator, based in each case on the solids content of the binder.

Photoinitiators (D) can be those, for example, which are known to the skilled worker, examples being those specified in “Advances in Polymer Science”, Volume 14, Springer Berlin 1974 or in K. K. Dietliker, Chemistry and Technology of UV- and EB-Formulation for Coatings, Inks and Paints, Volume 3; Photoinitiators for Free Radical and Cationic Polymerization, P. K. T. Oldring (Eds.) SITA Technology Ltd. London.

Suitable examples include mono- or bisacylphosphine oxides, as described for example in EP-A 7 508, EP-A 57 474, DE-A 196 18 720, EP-A 495 751 or EP-A 615 980, examples being 2,4,6-trimethylbenzoyldiphenylphosphine oxide (Lucirin® TPO from BASF AG), ethyl-2,4,6-trimethylbenzolyphenylphosphinate (Lucirin® TPOL from BASF AG), bis(2,4,6-trimethylbenzoyl)phenylphosphine oxide (Irgacure® 819 from Ciba Spezialitätenchemie), benzophenones, hydroxyacetophenones, 1-hydroxy-cylcohexyl phenyl ketone (Irgacure® 184 from Ciba Spezialitätenchemie), 1-(4-(2-hydroxyethoxy)phenyl)-2-hydroxy-2-methyl-1-propan-1-one (Irgacure® 2959 from Ciba Spezialitätenchemie), phenylglyoxylic acid and its derivatives or mixtures of these photoinitiators. Examples that may be mentioned include benzophenone, acetophenone, acetonaphthoquinone, methyl ethyl ketone, valorophenone, hexanophenone, α-phenybutyrophenone, p-morpholinoproplophenone, dibenzosuberon, 4-morpholinobenzophenone, 4-morpholinodeoxybenzoin, p-diacetylbenzene, 4-aminobenzophenone, 4′-methoxyacetonphenone, β-methylanthraquinone, tert-butylanithraquinone, anthraquinonecarboxylic esters, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacelybenzene, thioxanthen-9-one, xanthen-9-one, 2,4-dimethylthioxanthione, 2,4-diethylthioxanthone, 2,4-di-iso-propylthioxanthone, 2,4-dichlorothioxanthone, benzoin, benzoin iso-butyl ether, chloroxanthenone, benzoin tetrahydropyranyl ether, benzoin methyl ether, benzoin ethyl ether, benzoin butyl ether, benzoin iso-propyl ether, 7H-benzoin methyl ether, benz[de]anthracen-7-one, 1-naphthaldehyde, 4,4′-bis(dimethylamino)-benzophenone, 4-phenylbenzophenone, 4-chlorobenzophenone, Michler's ketone, 1-acetonaphthone, 2-acetonaphthone, 1-benzoylcyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12dione, 2,2-diethoxyacetophenone, benzyl ketals, such as benzyl dimethyl ketal, 2-methyl-1-[4-(methylthio)phenyl]-2-morpholino-propan-1-one, anthraquinones such as 2-methylanthraquinone, 2-ethylanthraquinone, 2-tert-butylanthraquinone, 1-chloroanthraquinone, 2-amylanthraquinone, and 2,3-butanedione.

Also suitable are non-yellowing or low-yellowing photoinitiators of the phenylglyoxalic ester type, as described in DE-A 198 26 712, DE-A 199 13 353 or WO 98/33761.

Examples of further typical coatings additives (E) are the following:
Rheology control addivies:
   Suitable rheology control additives include the typical and known compounds and mixtures which can be used to give a composition, preferably a coating material, an adhesive or a sealant, in particular a coating material, a pseudoplastic formulation/
   The rheology control additive are preferably selected from the group consisting of urea derivatives; crosslinked polymeric microparticles; inorganic phyllosilicates; silicas; synthetic polymers containing ionic and/or associative groups; cellulose derivatives; starch derivatives; hydrogenated castor oil; overbased sulfonates; and polyurethane-based associative thickeners.
   The inorganic phyllosilicates are preferably selected from the group consisting of aluminum magnesium silicates and sodium magnesium and sodium magnesium fluorine lithium phyllosilicates of the montmorillonite type; the silicas (B) are preferably selected from the group consisting of the nanoscale pyrogenic silicon dioxides and of silicon dioxides prepared by means of the sol-gel technology; the synthetic polymers (B) are preferably selected from the group consisting of polyvinyl alcohol, poly(meth)acrylamide, poly(meth)acrylic acid, polyvinylpyrrolidone, styrene-maleic anhydride or ethylene-maleic anhydride copolymers and their derivatives, and also polyacrylates; and the polyurethane-based associative thickeners are preferably selected from the group of hydrophobically modified ethoxylated polyurethanes (in this regard cf. Römpp Lexicon Lacke und Druckfarben, Georg Thieme Verlag, Stuttgart, New York, 1998, “Thickeners”, pages 599 to 600, and in the textbook “Lackadditive” [Additives for coatings] by Johan Bieleman, Wiley-VCH, Weinheim, New York, 1998, pages 51 to 59 and 65).
   Preference is given to using combinations of ionic and nonionic thickeners, as described in patent application DE 198 41 842 A1, page 4 line 45 to page 5 line 4, in order to impart pseudoplasticity to the powder slurries, or combinations of polyurethane-based associative thickeners and polyurethane-based wetting agents.
   Particular preference is given to using urea derivatives or mixtures comprising them, as described for example in patent applications WO 94/22968, EP 0 276 501 A1, EP 0 249 201 A1, WO 97/12945, DE 199 24 170 A1, column 2 line 3 to column 7 line 24, DE 199 24 171 A1, page 2 line 44 to page 5 line 53, DE 199 24 172 A1, page 2 lime 44 to page 3 line 32, DE 100 42 152A1, page 2 paragraph [0010] to page 6 paragraph [0066], and DE 101 26 647 A1, page 2 paragraph [0009] to page 6 paragraph [0066].
   The amount of the rheology control additives may likewise vary very widely. The amount is guided by the nature of the particular rheology control additive used and by the extent of the pseudoplastic effect it is desired to obtain. The rheology control additives are preferably used in the typical and known, effective amounts that are described in the prior art. Generally speaking these amounts are 0.1% to 40% and in particular 0.5% to 30% by weight, based in each case on the mixture of the invention.
Light stabilizers
   UV absorbers convert UV radiation into thermal energy. Known UV absorbers are hydroxybenzophenones, benzotriazoles, cinnamic esters and oxalanilides.

Free-radical scavengers bind radicals formed intermediately. Important free-radical scavengers include sterically hindered amines, which are known as HALS (Hindered Amine Light Stabilizers).
For outdoor applications the amount of UV absorbers and free-radical scavengers in all is preferably 0.1 to 5 parts by weight, more preferably 0.5 to 4 parts by weight, per 100 parts by weight of the radiation-curable compounds.
Further additives
   Further additives may be selected from the group consisting of color and/or effect pigments, molecularly dispersely soluble dyes; transparent fillers, such as nanoparticles based on silicon dioxide, aluminum dioxide or zirconium dioxide, or the compounds described in Römpp Lexikon “Lacke und Druckfarben”, Georg Thieme Verlag, Stuttgart, 1998, pages 250 to 252, antioxidants; low-boiling and high-boiling (“long”) organic solvents, such as aliphatic, aromatic and/or cycloaliphatic hydrocarbons, alkyl esters of acetic acid or propionic acid, alkanols, ketones, glycol ethers and/or glycol esters; deaerating agents; defoamers; wetting agents, such as siloxanes, fluorine compounds, carboxylic monoesters, phosphoric esters, polyacrylic acids and their copolymers, or polyurethanes; emulsifiers, especially nonionic emulsifiers, such as alkoxylated alkanols and polyols, phenols and alkylphenol, or anionic emulsifiers, such as alkali metal salts or ammonium salts of alkanecarboxylic acids, alkanesulfonic acids, and sulfo acids of alkoxylated alkanols and polyols, phenols and alkylphenols; slip additives; polymerization inhibitors; thermolabile free-radical initiators; adhesion promoters, such as tricyclodecanedimethanol; flow control agents; film-forming assistants, such as cellulose derivatives; flame retardants; corrosion inhibitors; free-flow aids; waxes; siccatives; biocides; and matting agents.
   Examples suitable constituents are known from patent applications DE 199 24 171 A1, page 5 line 48 to page 9 line 32, DE 100 42 152 A1, page 7 paragraph [0071] to page 11 paragraph [0093], and DE 101 54 030 A1, column 11 paragraph [0064] to column 12 paragraph [0071].
   The amount of the further additives in the mixtures of the invention may vary extremely widely and is guided by the nature of the particular constituents used. The constituents are preferably used in the typical and known, effective amounts.
   Moreover, the radiation-curable composition may, besides radiation-curable compounds, also comprise compounds which contribute to curing by means of other chemical reactions. Suitable examples include polyisocyanates, which crosslink with hydroxyl groups or amine groups.

The radiation-curable composition may be in water- and solvent-free form, in the form of a solution or in the form of a dispersion.

Preference is given to water-free and solvent-free, radiation-curable compositions or to aqueous solutions or aqueous dispersions.

Particular preference is given to water-free and solvent-free, radiation-curable composition.

The radiation-curable composition is thermoplastically deformable and may be extrudable.

The above radiation-curable compositions form the topcoat. The coat thickness (after drying and curing) is preferably 10 to 100 μm.

Likewise disclosed is a method of coating substrates, in which at least one coating composition of the invention is used.

The coating of the substrate takes place in accordance with customary methods which are known to the skilled worker, in which at least one coating material of the invention or paint formulation comprising it is applied to the substrate to be coated, in the desired thickness, and the volatile constituents of the coating material are removed, with heating where appropriate. This operation may if desired be repeated one or more times. Application to the substrate may take place in a known way, for example, by spraying, troweling, knifecoating, brushing, rolling, rollercoating or pouring. The coating thickness is generally in a range from about 3 to 1000 g/m² and preferably 10 to 200 g/m².

Disclosed in addition is a method of coating substrates which involves adding further typical coatings additives and thermally curable resins to the coating compositions of the invention or paint formulations comprising them, applying the resultant systems to the substrate, and drying them if appropriate, curing them with electron beams or by UV exposure under an oxygen-containing atmosphere of, preferably, under inert gas, if appropriate at temperatures up to the level of the drying temperature, and subsequently subjecting them to thermal treatment at temperatures up to 160° C., preferably, under inert gas.

Curing of the films formed on the substrate may if desired take place by means of heat alone. Generally speaking, and preferably, however, the coatings are cured both by exposure to high-energy radiation and thermally.

If appropriate, if two or more coats of the coating material are applied one above another, a thermal and/or radiation cure may take place after each coating operation.

Examples of suitable radiation sources for the radiation cure include low-pressure, medium-pressure and high-pressure mercury lamps, and also fluorescent tubes, pulsed lamps, metal halide lamps, electronic flash devices, which allow radiation curing without a photoinitiator, or excimer sources. The radiation cure is effected by exposure to high-energy radiation, i.e., UV radiation or daylight, preferably light in the wavelength range of λ=200 to 700 nm, more preferably of λ=200 to 500 nm, and very preferably λ=250 to 400 nm, or by bombardment with high-energy electrons (electron beams; 150 to 300 keV). Radiation sources used are, for example, high-pressure mercury vapor lamps, lasers, pulsed lamps (flashlight), halogen lamps or excimer sources. The radiation dose normally sufficient for crosslinking is, in the case of UV curing, in the range from 80 to 3000 mJ/cm².

It is of course also possible to use two or more radiation sources for curing, e.g., two to four.

These sources may also each emit in different wavelength ranges.

In addition to or instead of the thermal cure, curing may also be effected by means of NIR radiation, which here means electromagnetic radiation in the wavelength range from 760 nm to 2.5 μm, preferably from 900 to 1500 nm.

Irradiation may also be carried out, if appropriate, in the absence of oxygen, e.g., an inert gas atmosphere. Suitable inert gases include, preferably, nitrogen, noble gases, carbon dioxide or combustion gases. Irradiation may also be performed with the coating composition covered with transparent media. Transparent media are, for example, polymer films, glass or liquids, e.g., water. Particular preference is given to irradiation in the manner described in DE-A1 199 57 900.

The invention further provides a method of coating substrates which comprises
i) coating a substrate with a coating composition as described above,
ii) removing volatile constituents of the coating composition in order to form a film, under conditions in which the photoinitiator and/or thermal initiator as yet essentially forms no free radicals,
iii) if appropriate, subjecting the film formed in step ii) to high-energy irradiation, in the course of which the film is precured, and subsequently machining the article coated with the precured film, if appropriate, or contacting the surface of the precured film with another substrate, and
iv) subjecting the film to a final thermal cure.

Steps iv) and iii) may also be carried out in the opposite order, i.e., the film can be cured first thermally and then with high-energy radiation.

The coating compositions of the invention are particularly suitable for coating substrates such as wood, paper, textile, leather, nonwoven, plastic surfaces, glass, ceramic, mineral building materials, such as cement blocks and fiber cement slabs, or coated or uncoated metals, preferably for the coating of plastics or metals, which may be in the form, for example, of films or foils.

With particular preference the costing compositions of the invention are suitable as or in exterior coatings, i.e., in those applications where they are exposed to daylight, preferably on buildings or parts of buildings; interior coatings, traffic markings, coatings on vehicles and aircraft. In particular the coating compositions of the invention are used as or in automotive clearcoat and topcoat material(s).

in the case of use in films, particular substrates are preferred.

The substrate layer is composed preferably of a thermoplastic polymer, particularly polymethyl methacrylates, polybutyl methacrylates, polyethylene terephthalates, polybutylene terephthalates, polyvinylidene fluorides, polyvinyl chlorides, polyesters, polyolefins, acrylonitrile-ethylene-propylene-diene-stryene copolymers (A-EPDM), polyetherimides, polyetherketones, polyphenylene sulfides, polyphenylene ethers or blends thereof.

Mention may also be made of polyethylene, polypropylene, polystyrene, polybutadiene, polyesters, polyamides, polyethers, polycarbonate, polyvinyl acetal, polyacrylonitrile, polyacetal, polyvinyl alcohol, polyvinyl acetate, phenolic resins, urea resins, melamine resins, alkyd resins, epoxy resins or polyurethanes, block copolymers or graft copolymers thereof, and blends thereof.

With preference mention may be made of ABS, AES, AMMA, ASA, EP, EPS, EVA, EVAL, HDPE, LDPE, MABS, MBS, MF, PA, PA6, PA66, PAN, PB, PBT, PBTP, PC, PE, PEC, PEEK, PEI, PEK, PEP, PES, PET, PETP, PF, PI, PIB, PMMA, POM, PP, PPS, PS, PSU, PUR, PVAC, PVAL, PVC, PVDC, PVP, SAN, SB, SMS, UF, UP plastics (abbreviations in accordance with DIN 7728), and aliphatic polyketones.

Particularly preferred substrates are polyolefins, such as PP (polypropylene), which as desired may be isotactic, syndiotactic or atactic and as desired may be unoriented or may have been oriented by uniaxial or biaxial stretching, SAM (styrene-acrylonitrile copolymers), PC (polycarbonates), PMMA (polymethyl methacrylates), PBT (poly(butylene terephthalate(s), PA (polyamides), ASA (acrylonitrile-styrene-acrylate copolymers) and ABS (acrylonitrile-butadiene-styrene copolymers), and physical mixtures (blends) thereof. Particular preference is given to PP, SAN, ABS, ASA and to blends of ABS or ASA with PA or PBT or PC.

Very particular preference is given to ASA, especially in accordance with DE 19 651 350, and to the ASA/PC blend. Preference is likewise given to polymethyl methacrylate (PMMA) or to impact-modified PMMA.

The layer thickness is preferably 50 μm up to 5 mm. Particularly preferred, and especially if the substrate layer is injection backmolded, is a thickness of 100 to 1000 μm, in particular 100 to 500 μm.

The polymer of the substrate layer may comprise additives. Fillers or fibers are particularly appropriate. The substrate layer may also be colored and so act simultaneously as a coloring layer.

The present invention further provides for the use of the urethane (meth)acrylates of the invention in radiation-curable or dual-cure coating compositions.

The term “dual cure” or “multi cure” refers for the purposes of this specification to a curing operation which is accomplished by way of two or more than two mechanisms, selected for example from radiation curing, moisture curing, chemical curing, oxidative curing and/or thermal curing, preferably selected from radiation, moisture, chemical and/or thermal curing, more preferably selected from radiation, chemical and/or thermal curing, and with very particular preference radiation curing and chemical curing.

ppm and percentage figures used in this specification relate, unless otherwise indicated to percentages and ppm by weight.

The examples which follow are intended ti illustrate the invention but not to restrict it to these examples.

### EXAMPLES

### Example 1

A urethane acrylate was prepared from 400 parts of the isocyanurate of hexamethylene diisocyanate, 23.5 parts of a siloxane tetraol (prepared according to example 2 of U.S. Pat. No. 6,187,863), 182 parts of hydroxyethyl acrylate and 17 parts of methanol. Stabilization was accomplished from 0.3 part of hydroquinone monomethyl ether and 0.6 part of Kerobit® TBK. The components were combined (without methanol) and stirred at 40° C.

The viscosity is reduced by further adding 268 parts of hexanediol diacrylate. Following the addition of 0.1 part of dibutyltin dilaurate catalyst there was an exothermic reaction after which stirring was carried out at 60° C. for 2 hours.

The NCO value was 1.2%. The methanol was then added, and reaction was continued at 60° C. for 3 hours more. The NCO value had dropped to 0. The slightly turbid product was then characterized by IR and gel permeation chromatography.

### Comparative Example 1

The procedure of example 1 was repeated but using decanediol instead of the siloxane tetraol.

The coating materials were produced from the resins prepared in example 1 and in comparative example 1, respectively, with the addition of 4% by weight of Darocure® 1173 photoinitiator, a commercial photoinitiator from Ciba Spezialitätenchemie, with vigorous stirring by means of a dissolver or stirrer. Using a box-section coating bar, with a slot size of 200 μm, films were produced on clean glass plates. The films were cured in an IST coating installation with 2 UV lamps at a conveyor-belt speed of 10 m/min. The irradiated UV dose is approximately 1800 mJ/cm².

The pendulum hardness, Erichsen cupping and scratch resistance, by the Scotchbrite test, of these coating materials was determined after storage for 24 hours in a controlled-climate chamber. The scratch resistance was determined by applying a film to a cleaned glass plate colored black. This allows the degree of scratching to be determined via determination of the drop in gloss after corresponding stressing.

TABLE 1
Test results of the coatings of example
1 and comparative example 1

| | Pendulum | Erich- | Delta gloss | Delta gloss | Delta gloss |
|---|---|---|---|---|---|
| | hardness | sen | (20°; 250 g) | (20°; 750 g) | (60°; 250 g) |
| Ex. 1 | 172 s | 3.5 mm | 20% | 41% | 8% |
| Comp. | 170 s | 4 mm | 27% | 52% | 11% |
| ex. 1 | | | | | |

1) Delta gloss after Scotch-Brite treatment at a measurement angle of 20° or 60° and applied weights of 250 g or 750 g, 10 double strokes (DS).
2) König pendulum hardness, DIN 53 157, ISO 1522.
3) Erichsen cupping, DIN 53 156, ISO 1520.

The Scotch-Brite test proceeds a follows: the test body is a 3×3 cm silicon carbide modified fiber fleece (Scotch Brite SUFN, 3M Deutschland, 41453 Neuβ) which is affixed to a cylinder. This cylinder presses the fiber fleece onto the coating with the specified applied weight, and is moved pneumatically over the coating. The path length of the deflection is 7 cm. After the stated number of double strokes the gloss is measured (sixfold determination) at the specified angle, along the lines of DIN 67530, ISO 2813, in the middle region of the stressing.

Delta gloss describes the loss of gloss as a result of the scratching load; in other words, the lower the delta gloss value, the better the scratch resistance. While the hardness and elasticity are virtually the same in coatings produced according to example 1 and to comparative example 1, the scratch resistance is significantly improved as a result of the addition of the siloxane component.

### Example 2

Isopropylidenedicyclohexanol was coarsely dispersed in 2-hydroxyethyl acrylate and polysiloxane from example 1 at 60° C. with stirring. To this suspension there were added the isocyanates, hydroquinone monomethyl ether, 1,6-di-tert-butyl-para-cresol and butyl acetate. Following the addition of dibutyltin dilaurate, the mixture heated up. Stirring was carried out for a number of hours at an internal temperature of 75° C., until there was virtually no longer any change in the NCO value of the reaction mixture. Then methanol was added until an NCO value of 0% was reached.

| | | |
|---|---|---|
| Isopropylidenedicyclohexanol | 44.28 g | (35 mol % OH) |
| 2-Hydroxyethyl acrylate | 63.80 g | (55 mol % OH) |
| Polysiloxane | 14.13 g | (5.6 mol % OH) |
| Basonat ® HI 100 from BASF AG | 72.38 g | (37.5 mol % NCO) |
| Basonat ® HB 100 from BASF AG | 69.35 g | (37.5 mol % NCO) |
| Vestanat ® T 1890 from Degussa | 60.70 g | (25 mol % NCO) |
| Hydroquinone monomethyl ether | 0.164 g | (0.05% on solids) |
| 1,6-di-tert-butyl-para-cresol | 0.328 g | (0.1% on solids) |
| Butyl acetate | 176.43 g | (63% solids) |
| Dibutyltin dilaurate | 0.066 g | (0.02% on solids) |
| Methanol | 2.05 g | (5 mol % OH) |

Basonat® HI 100 from BASF: polyisocyanate (isocyanurate) based on hexamethylene diisocyanate, NCO content: 21.5-22.5% (DIN EN ISO 11909)

Basonat® HB 100 from BASF: polyisocyanate (biuret) based on hexamethylene diisocyanate, NCO content: 22-23% (DIN EN ISO 11909)

Vestanat® 1890 from Degussa: polyisocyanate (isocyanurate) based on isophorone diisocyanate, NCO content: 11.7-12.3% (DIN EN ISO 11909)

The properties possessed by the urethane acrylate obtained by the above process are as follows:
glass transition temperature T_{g}=22.0° C.
Viscosity η=10.7 Pa·s/RT (measured in a cone and plate viscometer at a temperature of 23° C.)
Double bond density =1.68 mol/kg (in 100% form)

### Example 3

Preparation of a Coating Formulation Comprising Urethane Acrylate

100 parts of the urethane acrylate described in example 2 are admixed with 4 parts of Irgacure® 184 from Ciba (commercial photoinitiator) and mixed intensively by means of a dissolver or stirrer.

The clearcoat films were produced with a box-section doctor blade (slot size: 400 μm on cleaned glass plates; slot size: 200 μm on Bonder metal sheet) on cleaned glass plates or on Bonder metal sheet.

The wet films were first flashed off at room temperature for 15 minutes and then dried at 100° C. for 20 minutes. The films were cured in an IST coating installation (type M 40 2×1-R-IR-SLC-So inert) with 2 UV lamps (high-pressure mercury lamps type M 400 U2H and type M 400 U2HC) with a conveyor-belt speed of 10 m/min under a nitrogen atmosphere ((O₂) content ≦500 ppm). The radiation dose was approximately 1900 mJ/cm².

The mechanical stability was determined following storage of the fully cured film for 24 hours in a climate-controlled chamber. Determinations were made of the König pendulum damping (DIN 53 157, ISO 1522), the Erichsen cupping (DIN 53 156, ISO 1520), and the pencil hardness.

| | | Pendulum | Erichsen | |
|---|---|---|---|---|
| | Film thickness | damping | cupping | |
| | (Bonder sheet) | (glass plate) | (Bonder sheet) | Pencil |
| Example | [μm] | [s] | [mm] | hardness |
| 1 | 51.3 ± 0.9 | 159 | 2.0 | H |

### Example 4

79.70 g of isopropylidenedicyclohexanol were dispersed coarsely with stirring in 63.03 g of 2-hydroxyethyl acrylate, 296.01 g of a mixture of pentaerythritol triacrylate and tetraacrylate (PETIA from UCB) and 28.11 g of the siloxanediol described below, at 60° C. This suspension was admixed with 238.84 g of Basonat® HI 100 from BASF AG, 126.09 g of Desmodur® W from Bayer Material Science AG, 0.435 g of hydroquinone monomethyl ether, 0.896 g of 1,6-di-tert-butyl-para-cresol and 381.53 g of MEK (i.e., methyl ethyl ketone). Following the addition of 0.174 g of dibutyltin dilaurate there was an increase in the temperature of the batch. The batch was stirred at an internal temperature of 70° C. for 7.5 h hours until there was virtually no longer any change in the NCO value of the reaction mixture. Then 7.69 g of methanol and 17.36 g of glycolic acid were added and the batch was stirred further until an NCO value of 0% was reached.

PETIA from UCB: mixture of pentaerythritol triacrylate and tetraacrylate with a double bond content of about 9 mol/kg and an OH number of 100 to 115 mg KOH/g

Siloxanediol: reaction product (hydrosilylation) of 114 g of allyl alcohol propoxylate (M=151.1 g/mol. OH number=371 mg KOH/g) with 93.26 g of hydride-terminated polydimethylsiloxane (M=400-500 g/mol).

Basonat® HI 100 from BASF: polyisocyanate (isocyanurate) based on hexamethylene diisocyanate, NCO content: 21.5-22.5% (DIN EN ISO 11909)

Desmodur® W from Bayer Material Science AG: dicyclohexylmethane diisocyanate with an NCO content of ≧31.8%.

The urethane acrylate obtained by the above method has the following properties:
Glass transition temperature T_{g}=3.9° C.,
Viscosity η=1.1 Ps·s/RT (measured in cone/plate viscometer at a temperature of 23° C.),
Double bond density=2.6 mol/kg (in 100% form)
Acid number AN=16.12 mg KOH/g (in 100% form)

### Example 5

Preparation of a Urethane Acrylate Coating Formulation 2

145 parts by weight of the silicone-modified urethane acrylate obtained in example 4.

2 parts by weight of HALS light stabilizer Tinuvin 152 from Ciba Spezialitätenchemie (50% in MEK).

1.8 parts by weight of Tinuvin® 400 from Ciba Spezialitätenchemie,

1.4 parts by weight of Lutensol® AT 50 from BASF AG,

2.2 parts by weight of triethylamine and

4 parts by weight of a mixture of photoinitiators (Irgacure® 184 from Ciba Spezialitätenchemie/triphenylphosphine oxide, 5.1)

are combined and slowly admixed with 96 parts by weight of DI water, with stirring, and then again admixed with 96 parts by weight of DI water. After mixing, the composition is filtered through a 1 μm Cuno filter.

Tinuvin® 152: light stabilizer from Ciba Spezialitätenchemie, comprising a triazine group and two cyclic, sterically hindered amino ether groups

Tinuvin® 400 from Ciba Spezialitätenchemie: mixture of 2-4(2-hydroxy-3-undecycloxypropyl)oxyl)-2-hydroxyphenyl)-4,6-bis(2,4-dimethylphenyl)-1,3,5-triazine and 2-(4-(2-hydroxy-3-tridecyloxypropyl)oxyl)-2-hydroxyphenyl)-4,6-bis(2,4-dimethylphenyl-1,3,5-triazine

Lutensol AT 50=surfactant from BASF AG

Irgacure® 184 from Ciba Spezialitätenchemie: commercially customary photoinitiator based on 1-hydroxycyclohexyl phenyl ketone

Thereafter the solvent is evaporated off by open stirring at room temperature for 24 h. Following filtration, the mixture is made up with 0.2 part by weight of Baysilone® AI 3468 (flow control additive from Bayer AG) and 1.0 part by weight of Acrysol RM•8W (PU) thickener from Rohm & Haas) and again filtered through a 1 μm Cuno filter.

For the coating material tests, the clearcoat was applied horizontally to conventional cathodically electrocoated metal panels, which should first be coated with a typical waterborne surfacer and subsequently with a black waterborne basecoat (initial drying for 10′ at 80° C.)

The clearcoat was dried thermally 10′60° C., 6′80° C., 15′155° C. and thereafter irradiated with 1.5 J/cm² (Light Bug ILD 390C from Polytec) in an oxygen-depleted (1% O₂) atmosphere in an IST UV unit from IST Metz GmbH. The dry film thickness of the clearcoat is 40 μm.

The coating had a very smooth surface (mirror optics) and also, when applied at relatively high coat thicknesses, was extremely pop-free (well above 80 μm). Furthermore, the clearcoat is very highly chemical-resistant, stonechip-resistant, hard scratch-resistant, and stable to condensation. In detail, the following test results were obtained:

Daimier-Chrysler gradient oven

| | | |
|---|---|---|
| Sulfuric acid | 48° | C. |
| Sodium hydroxide solution | 52° | C. |
| Tree resin | >75° | C. |
| DI water | >75° | C. |

VDA stonechip 612-b 427
Characteristic value 1.5-degree of rusting 0.5
Hardness (Fisherscope penetration hardness)
122 N/mm² at 25.6 mN, relative elastic resilience 63%
Scratch resistance, AMTEC laboratory wash unit
80% residual gloss
Scratch resistance, Crockmeter 9 μm
87% residual gloss
Condensation test (constant conditions, 240 h)
Blistering, amount=0, size=0

1. A radiation-curable or radiation- and heat-curable binder, comprising as synthesis components:
(a) at least one compound having at least one isocyanate group (—NCO),
(b) at least one compound comprising at least one silicon atom and at least one isocyanate-reactive group, and
(c) at least one compound having at least one isocyanate-reactive group and at least one free-radically polymerizable group.

2. The radiation-curable binder of claim 1, wherein the amount of component (c) comprises at least 25 mol % with respect to the isocyanate groups of component (a).

3. The radiation-curable binder of claim 1, wherein the isocyanates (a) are aliphatic, cycloaliphatic diisocyanates, polyisocyanates, or a combination thereof.

4. The radiation-curable binder of claim 1, wherein synthesis component (b) comprises at least one organic polysiloxane having reactive functional groups, said polysiloxane having the following structure according to formula (I): 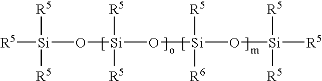
or according to formula (II): 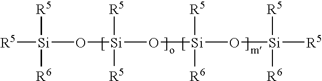
in which,
m is at least 1,
m′ is 0 to 50,
o is 0 to 50,
R⁵ is selected from the group consisting of OH and monovalent hydrocarbon groups which are attached to the silicon atoms, and
R⁶ has the following structure of the formula (III):
R⁷—O-Z
in which,
R⁷ is alkylene, oxyalkylene, or alkylenearyl, and
Z is hydrogen or a unit which comprises a functional group selected from the group consisting of —OH, —COOH, —NCO, carboxylate, such as ester, carbonate and anhydride, primary amine, secondary amine, amide, carbamate and epoxy-functional group.

5. The radiation-curable binder of claim 4, wherein o+m together are 2 or 3 or o+m′ are 2 or 3.

6. The radiation-curable binder of claim 1, wherein at least one compound having at least one isocyanate reactive group and at least one dispersive group (f) is present as a synthesis component.

7. The radiation-curable binder of claim 6, wherein at least one compound (f) is of the formula:
RG-R³DG
in which,
RG is at least one isocyanate-reactive group,
DG is at least one dispersive group, and
R³ is an aliphatic, cycloaliphatic or aromatic radical comprising 1 to 20 carbon atoms.

8. A radiation-curable or radiation- and heat-curable coating composition, comprising:
(A) the radiation curable or radiation and heat-curable binder of claim 1, and
(D) at least one photoinitiator.

9. A substrate is coated with the radiation-curable or radiation- and heat-curable coating composition of claim 8.

10. A method of coating a substrate, comprising applying the radiation-curable or radiation and heat-curable coating composition of claim 8 to a substrate.

11. The radiation-curable binder of claim 1, further comprising at least one compound having at least two isocyanate reactive groups (d) as a synthesis component.

12. The radiation-curable binder of claim 1, further comprising at least one compound having one isocyanate reactive group with no further functional groups (e) as a synthesis component.

13. The radiation-curable coating composition of claim 8, further comprising at least one polymer having ethylenically unsaturated groups and an average molar mass Mₙ of more than 2000 g/mol (B).

14. The radiation curable coating composition of claim 8, further comprising at least one compound having ethylenically unsaturated groups and an average molar mass Mₙ of less than 2000 g/mol (C).
